(19) United States
(12) Patent Application Publication
(10) Pub. No.: US 2026/0008308 A1
(43) Pub. Date: Jan. 8, 2026

(54) SPRING LOADED ACCESSORY MOUNT FOR TRAILER HITCH RECEIVER

(71) Applicant: B & W Custom Truck Beds, Inc., Humboldt, KS (US)

(72) Inventor: Austin Rasmussen, Toronto, KS (US)

(73) Assignee: B & W Custom Truck Beds, Inc., Humboldt, KS (US)

(21) Appl. No.: 19/239,579

(22) Filed: Jun. 16, 2025

Related U.S. Application Data
(60) Provisional application No. 63/668,622, filed on Jul. 8, 2024.

(51) Int. Cl. B60D 1/60

(52) U.S. Cl. CPC B60D 1/60

(57) ABSTRACT

An accessory mount is configured to be slidably inserted into a receiver bore of a hitch receiver for removable engagement therewith. The accessory mount includes a mount frame, a lower guide, and an upper retainer. The mount frame includes a frame axis along which the accessory mount is inserted and removed relative to the hitch receiver. The lower guide is associated with the mount frame and presents a downwardly-facing first guide surface slidably engaged with the hitch receiver when the accessory mount is inserted in the receiver bore. The upper retainer is shiftably attached relative to the mount frame and is located opposite the lower guide. The upper retainer presents an upwardly-facing second guide surface. The upper retainer is biased upwardly so that the first and second guide surfaces are urged into frictional engagement with the hitch receiver when the accessory mount is inserted into the receiver bore.

### CROSS REFERENCE TO RELATED APPLICATIONS

This application claims the benefit of U.S. Provisional Patent Application Ser. No. 63/668,622, entitled Spring Loaded Accessory Mount for Trailer Hitch Receiver, filed Jul. 8, 2024, the disclosure of which is incorporated herein in its entirety by reference.

### BACKGROUND

### 1. Field

Embodiments of the invention relate generally to hitch receivers. More specifically, the disclosed embodiments are related to an accessory mount for removable attachment to a hitch receiver.

### 2. Related Art

Accessories which may be attached to a hitch receiver are generally known in the art. These accessories, such as covers, may be attached to the hitch receiver for an aesthetic benefit, or to provide additional utility such as protecting the bumper of the vehicle and/or protecting the hitch receiver itself. One such example of a cover is shown in U.S. Pat. No. 8,752,856 to Sarajian et al., which discloses a hitch cover that includes a faceplate, a shaft, and an adapter, and which is inserted into the hitch receiver. Likewise, U.S. Patent Application No. 2005/0121880 to Santangelo discloses a receiver tube mounted trailer hitch cover that fills a bumper fascia opening through which a hitch receiver is accessed. While these existing solutions may be adequate for a specific use, some may be limited to merely an aesthetic benefit, may be prone to failure during repeated use, or may be difficult for a user to set up. Therefore, it would be advantageous for an accessory mount to have modular components and utilize a more robust attachment means than existing solutions to provide increased versatility and utility.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, an accessory mount is configured to be slidably inserted into a receiver bore of a hitch receiver for removable engagement with the hitch receiver. The accessory mount broadly includes a mount frame, a lower guide, and an upper retainer. The mount frame defines a frame axis along which the accessory mount is inserted and removed relative to the receiver bore of the hitch receiver. The lower guide is associated with the mount frame and presents a downwardly-facing first guide surface slidably engaged with the hitch receiver when the accessory mount is inserted in the receiver bore. The upper retainer is shiftably attached relative to the mount frame and located opposite the lower guide. The upper retainer presents an upwardly-facing second guide surface, with at least part of the upper retainer being biased upwardly so that the first guide surface and the second guide surface are urged into frictional engagement with the hitch receiver when the accessory mount is inserted into the receiver bore.

In another embodiment, an accessory mount is configured to be slidably inserted into a hitch receiver for removable engagement with a receiver bore of the hitch receiver. The accessory mount broadly includes a mount frame, an upper retainer, and a spring. The mount frame includes a mount frame base and side walls that extend axially between first and second frame ends, with the side walls projecting from respective side margins of the mount frame base. The mount frame base and side walls include a frame axis along which the accessory mount is inserted and removed relative to the receiver bore of the hitch receiver. The mount frame base presents a downwardly-facing first guide surface slidably engaged with the hitch receiver when inserted in the receiver bore. The upper retainer is pivotally attached adjacent the first frame end of the mount frame. The spring operably engages the upper retainer to urge the upper retainer away from the mount frame base. The upper retainer presents an upwardly-facing second guide surface, with at least part of the upper retainer being biased upwardly by the spring so that the first guide surface and the second guide surface are urged into frictional engagement with the hitch receiver when the accessory mount is inserted into the receiver bore. The upper retainer includes a pair of spaced projections located adjacent the second frame end of the mount frame base. The side walls each define a slot that shiftably receives a respective one of the projections and permits pivotal movement of the upper retainer relative to the mount frame base. The side walls each include a stop that terminates a corresponding slot, with engagement of a respective stop by a corresponding projection limiting upward movement of the upper retainer relative to the mount frame base.

### BRIEF DESCRIPTION OF THE DRAWING FIGURES

Embodiments of the invention are described in detail below with reference to the attached drawing figures, wherein:

FIG. 1 is a perspective view of an accessory mount having an accessory attached thereto; the accessory mount being slidably inserted into a receiver bore of a hitch receiver;

FIG. 2 is another perspective view of the accessor and accessor mount of FIG. 1;

FIG. 3 is a side cross-section view of the accessory and accessory mount of FIG. 1 slidably inserted into a receiver bore of a hitch receiver;

FIG. 4 is a top cross-section view of the accessory mount of FIG. 1 slidably inserted into a receiver bore of a hitch receiver;

FIG. 5 is a partial, exploded perspective view of the accessory and accessory mount of FIG. 1;

FIG. 6 is a perspective view of the accessory mount of FIG. 1;

FIG. 7 is another perspective view of the accessory mount of FIG. 1;

FIG. 8 is a side cross-section view of the accessory mount of FIG. 1;

FIG. 9 is a top cross-section view of the accessory mount of FIG. 1; and

FIG. 10 is an exploded perspective view of the accessory mount of FIG. 1.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

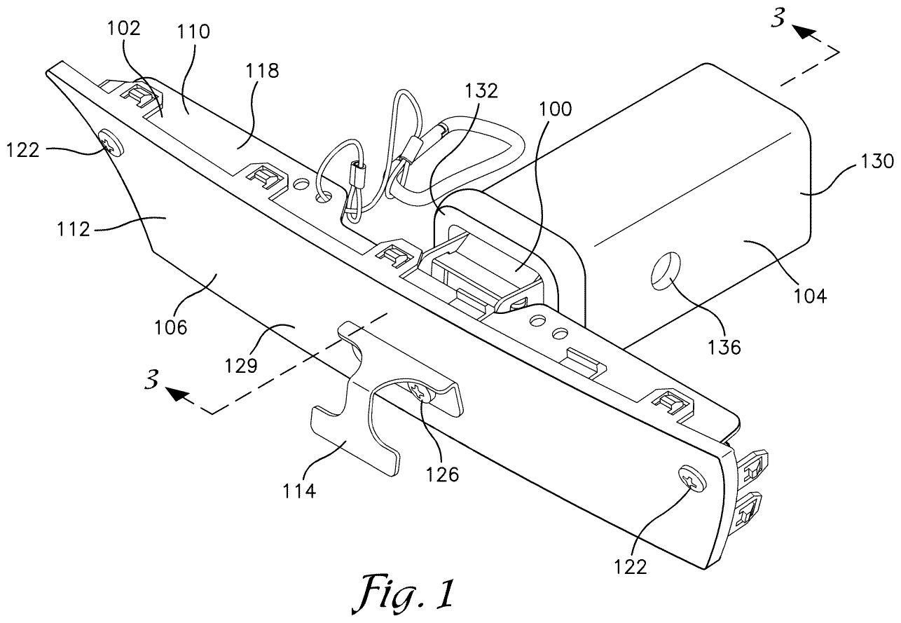

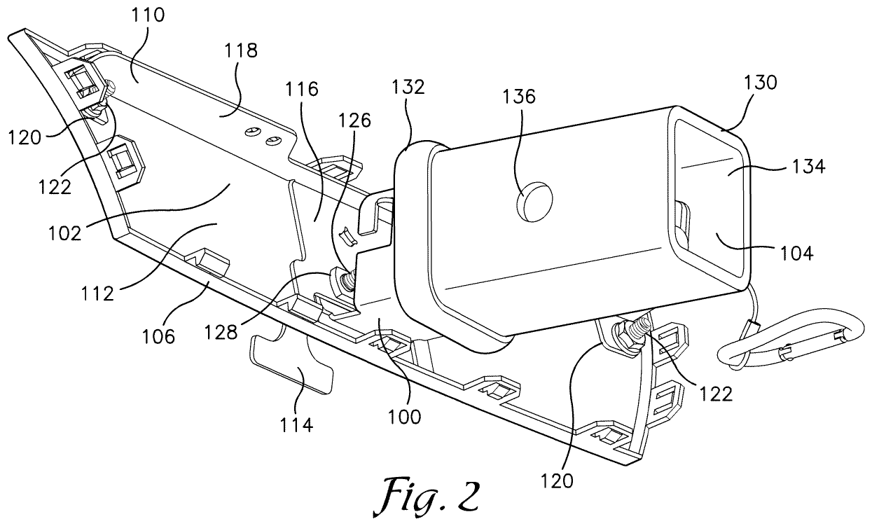

Turning initially to FIGS. 1-5, an accessory mount 100 is configured to be used to removably attach an accessory 102 to a hitch receiver 104 connected to a towing vehicle (not shown). The hitch receiver 104 may be fixed relative to a chassis of the vehicle for removable attachment of a hitch ball assembly thereto to which a trailer (not shown) or other towed vehicle may be coupled. In the customary manner, the hitch receiver 104 may be located adjacent an aft end of the vehicle to interconnect the towing vehicle and trailer and permit the trailer to be towed behind the towing vehicle. However, when a trailer is not coupled to the vehicle, the hitch ball assembly may be removed and the hitch receiver 104 may be used to removably receive the accessory mount 100 supporting the accessory 102.

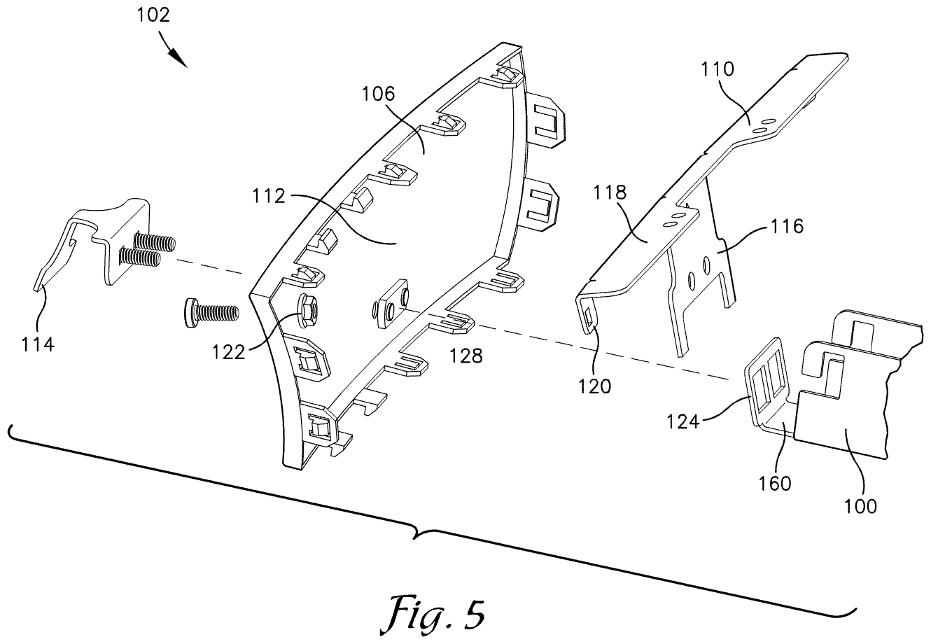

In the embodiment shown, the accessory 102 may be configured to cover and/or hide the hitch receiver 104 when the hitch receiver 104 is not attached to a towed vehicle. Accessory 102 includes an accessory cover 106 removably attached to the accessory mount 100. The depicted accessory cover 106 includes a frame 110, a curved cover body 112, and a grip 114 (see FIG. 1) secured to one another with fasteners. Frame 110 may have a unitary construction with a mounting plate 116 and an elongated flange 118 extending laterally outboard of the mounting plate 116. Frame 110 may further include tabs 120 extending from flange 118 (see FIG. 5) for attachment to adjacent portions of the cover body 112 via fasteners 122 (see FIGS. 1-3). The cover body 112, grip 114, and mounting plate 116, may be removably secured to an aft mounting bracket 124 of the accessory mount 100 with a pair of screws 126 threaded into a common nut 128 (see FIGS. 1-3).

When a hitch is not secured within hitch receiver 104, the hitch receiver 104 may removably receive an accessory, such as accessory 102. For example, the accessory cover 106 may be configured to cover the hitch receiver 104 when a trailer is not attached to the towing vehicle. In non-towing configurations, the accessory cover 106 may generally enhance the aesthetic appearance of the vehicle. In at least certain embodiments, the accessory cover 106 may be configured and positioned to cover and/or hide the hitch receiver 104. Embodiments of the accessory 102 may be configured so that an outer surface 129 (see FIG. 1) of the accessory cover 106 generally conforms to an outer surface of the vehicle (such as a rear bumper surface).

It is also within the scope of at least certain embodiments for an accessory to have one or more features not provided for aesthetic purposes. For instance, at least some embodiments of accessories may include a structure (such as a tray, post, rack, hook, box, lid, crate, clamp, etc.) for storing or supporting one or more items.

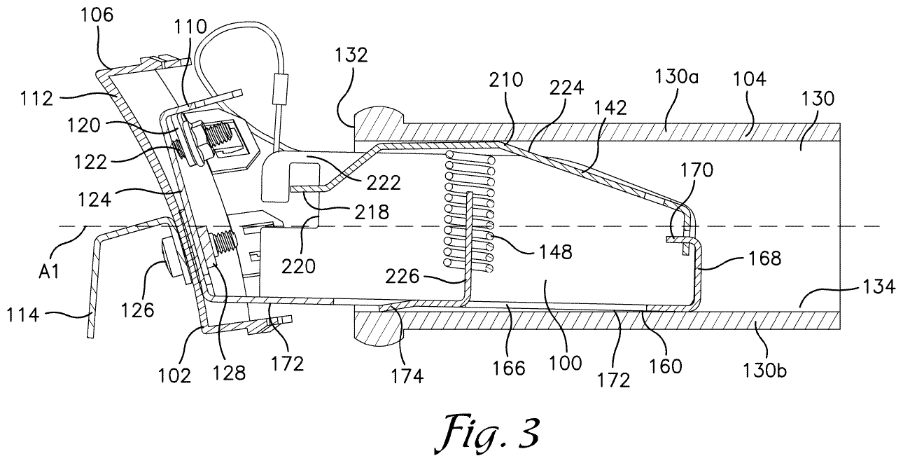

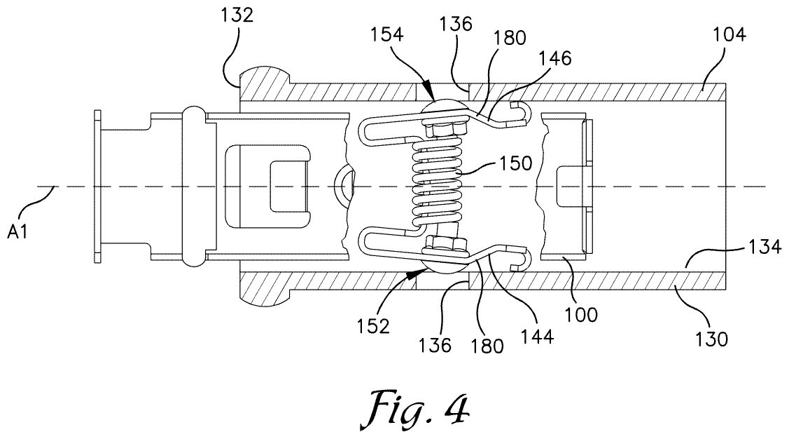

Referring to FIGS. 1-4, the hitch receiver 104 shown includes a unitary tube 130 that defines a receiver axis A1 (see FIGS. 3 and 4). Tube 130 extends forwardly from an aft end 132 and presents a receiver bore 134. As will be described below, the hitch receiver 104 may slidably receive the accessory 102 within the receiver bore 134. Tube 130 also presents a pair of opposite holes 136 that are axially aligned with one another to receive a pin (not shown) or other fastener for coupling a hitch ball assembly or other structure to the receiver 104.

The accessory cover 106 may be removably supported relative to the hitch receiver 104 by the accessory mount 100 (see FIGS. 1-3). As will be explained, accessory mount 100 may be configured to be slidably inserted into the hitch receiver 104 for removable engagement with the receiver bore 134 of the hitch receiver 104.

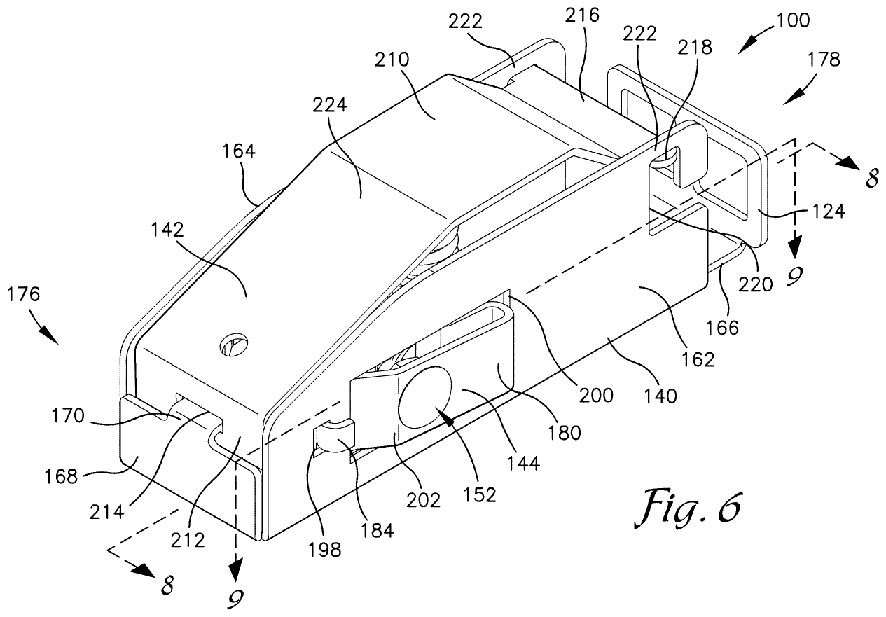

Turning to FIGS. 6-10, embodiments of the accessory mount 100 may include a mount frame 140, an upper retainer 142, side retainers 144 and 146, springs 148 and 150, and detents or fasteners 152 and 154. As described below, the upper retainer 142 and side retainers 144 and 146 may be operably supported by the mount frame 140. Furthermore, in preferred embodiments, the upper retainer 142 and side retainers 144 and 146 may cooperate with the mount frame 140 to frictionally engage the hitch receiver 104 when the accessory mount 100 is inserted into the receiver bore 134.

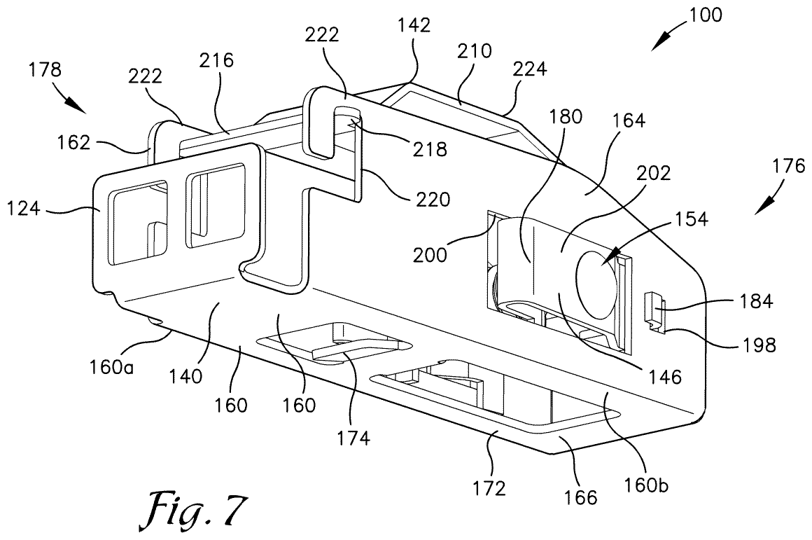

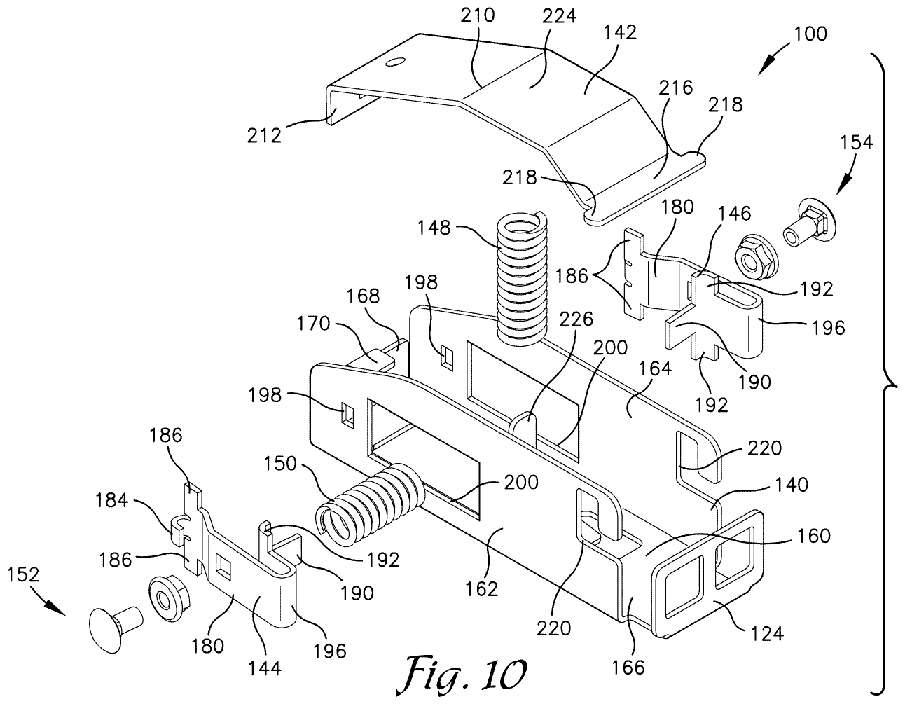

The illustrated mount frame 140 may comprise a unitary, sheet metal structure that is formed to include a mount frame base 160, side wall 162, and side wall 164. Mount frame base 160 may include a bottom plate 166, an upturned forward bracket 168 with a rearwardly extending tab 170, and the upturned aft mounting bracket 124 (see FIG. 10). Bottom plate 166 of mount frame base 160 may provide a lower guide associated with the mount frame 140. Bottom plate 166 may present a downwardly-facing lower guide surface 172 slidably engaged with the hitch receiver 104 when inserted in the receiver bore 134 (see FIG. 3). Bottom plate 166 may further define a tab 174 extending at a downwardly canted angle relative to the lower guide surface 172 (see FIGS. 3 and 7). It will be appreciated that tab 174 may extend below at least part of the lower guide surface 172 to frictionally engage the hitch receiver 104 (see FIG. 3).

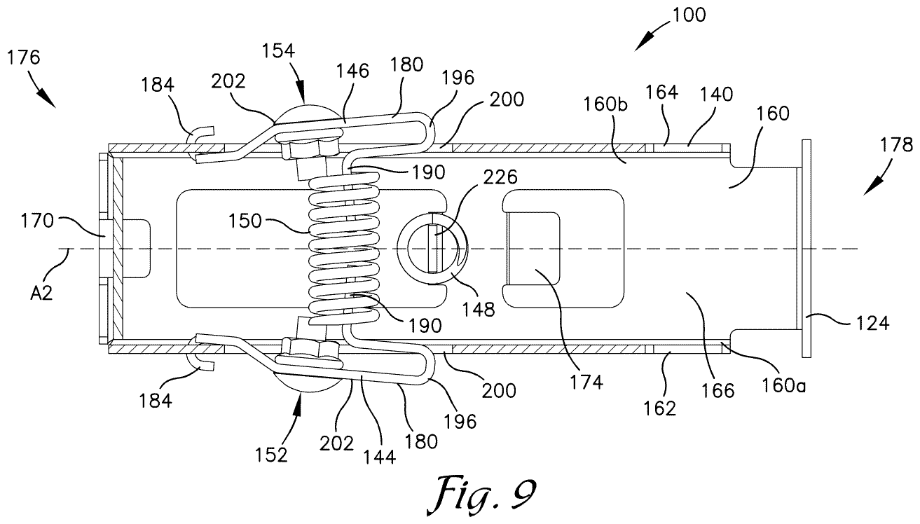

The mount frame base 160 and side walls 162 and 164 may extend axially between forward and aft frame ends 176 and 178 (see FIG. 6). Side walls 162 and 164 may be upturned relative to the bottom plate 166 and project from respective side margins 160a and 160b of the mount frame base 160 (see FIGS. 7 and 9). Mount frame base 160 and side walls 162 and 164 may define a frame axis A2 (see FIG. 9) along which the accessory mount 100 is inserted and removed relative to the hitch receiver 104.

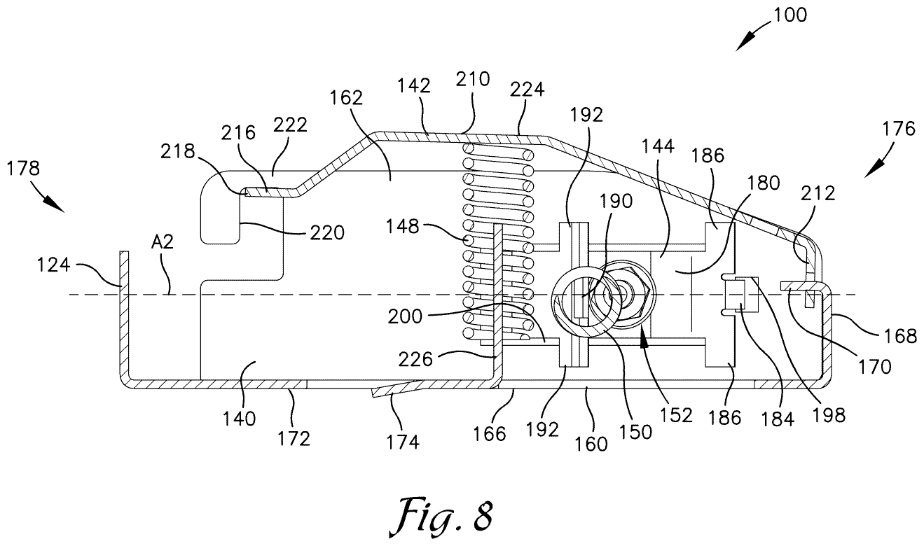

Turning to FIGS. 6-10, the side retainers 144 and 146 may be operably supported by the mount frame 140 for lateral shifting movement relative to the mount frame 140. As used herein, lateral shifting includes lateral pivoting of the side retainers 144 and 146 relative to the mount frame side walls 162 and 164. As described below, side retainers 144 and 146 may be biased outwardly for frictional engagement with the hitch receiver 104. Side retainers 144 and 146 may each include a retainer body 180. Each retainer body 180 may include a pivotal end connector 184 and opposite tabs 186 (see FIGS. 8-10). The end connector 184 may comprise a hook located between the tabs 186. Each retainer body 180 may also include a shiftable end connector 190 and opposite tabs 192 (see FIGS. 8-10). The end connector 190 may comprise a projection located between the tabs 192. The retainer body 180 may be folded onto itself to form a bight 196 (see FIGS. 9 and 10), with the shiftable end connector 190 being located between the pivotal end connector 184 and the bight 196.

Side retainers 144 and 146 may be spaced on opposite sides of the upper retainer 142 and the mount frame base 160. Each side retainer 144 and 146 may be mounted relative to a corresponding side wall 162 and 164 by pivotally attaching the pivotal end connector 184 relative to the side wall 162 and 164. In the depicted embodiment, the pivotal end connector 184 is inserted into connector openings 198 (see FIGS. 6-8). The tabs 186 located adjacent the pivotal end connector 184 may engage the corresponding side wall 162 and 164 (see FIG. 8) to restrict outboard shifting or pivoting of the side retainer 144 and 146.

The retainer body 180 is also shiftably received by a corresponding retainer opening 200 (see FIGS. 6-9). Similar to tabs 186, the tabs 192 located adjacent the shiftable end connector 190 may engage the corresponding side wall 162 and 164 (see FIG. 8) to restrict outboard shifting or pivoting of the side retainer 144 and 146.

Each retainer body 180 may be oriented so that the end connectors 190 project inwardly relative to the mount frame 140. In this manner, the spring 150 may be cooperatively supported by the illustrated end connectors 190. When supported on the end connectors 190, spring 150 may operably interengage the side retainers 144 and 146. Preferably, spring 150 may be compressed to urge the side retainers 144 and 146 away from each other toward outboard positions (see FIG. 9).

Side retainers 144 and 146 are shiftable into and out of outboard positions (see FIG. 9) in which tabs 186 and 192 engage respective side walls 162 and 164. As noted above, tabs 186 and 192 engage the side walls 162 and 164 to restrict outboard shifting of the side retainers 144 and 146 beyond the outboard positions.

Side retainers 144 and 146 may present respective, outwardly-facing side guide surfaces 202 (see FIGS. 6, 7, and 9). Side retainers 144 and 146 may be biased outwardly by spring 150 so that the side guide surfaces 202 are urged into frictional engagement with the hitch receiver 104 when the accessory mount 100 is inserted into the receiver bore 134 (see FIG. 4).

Preferably, fasteners or detents 152 and 154 may be secured to respective retainer bodies 180 to define at least parts of the side guide surfaces 202 (see FIGS. 6, 7, and 9). The fasteners 152 and 154 may provide respective outwardly-facing detents 204 and 206 configured to removably engage the side walls 162 and 164. The depicted detents 204 and 206 may present at least portions of the side guide surfaces 202.

Side retainers 144 and 146 and spring 150 cooperatively permit shifting of the side retainers 144 and 146 between the outboard position (see FIG. 9) and a range of inboard positions (for example, see FIG. 4). Although spring 150 may be partially compressed in the outboard position, it will be appreciated that spring 150 may be further compressed as the side retainers 144 and 146 are shifted inboard toward each other. For instance, as the side retainers 144 and 146 of accessory mount 100 are shifted forwardly into engagement with the hitch receiver 104, it will be understood that side retainers 144 and 146 may be engaged and urged inboard by the tube 130.

As noted above, side retainers 144 and 146 may be biased outwardly for frictional engagement with the hitch receiver 104. For example, when the accessory mount 100 is located in a secured position, side retainers 144 and 146 may be biased outwardly by spring 150 so that the detents 152 and 154 are urged into removable frictional engagement with holes 136 (see FIG. 4).

Although the illustrated side retainers 144 and 146 may be preferred as part of the accessory mount 100, one or both side retainers may be alternatively configured (e.g., for providing frictional engagement between the accessory mount and the hitch receiver). For certain aspects of the present invention, embodiments of the accessory mount may have only one side retainer or may be devoid of side retainers.

Still referring to FIGS. 6-10, the upper retainer 142 may be operably supported by the mount frame 140 for shifting movement, including pivotal movement, relative to the mount frame 140. Upper retainer 142 may include a retainer body 210 with a pivotal end connector 212 (see FIGS. 8-10). The end connector 212 may comprise an end tab and present a slot 214 (see FIG. 6). The retainer body 210 may also include a shiftable or pivotable end connector 216 with a pair of spaced projections 218 (see FIGS. 6, 7, and 10).

Upper retainer 142 may be pivotally attached adjacent the forward frame end 176 of the mount frame 140. For example, the pivotal end connector 212 may be attached to the forward bracket 168 of the mount frame 140 by inserting the tab 170 into the slot 214 of the end connector 212 (see FIG. 6). The upper retainer 142 may also be shiftably or pivotably attached adjacent the aft frame end 178 of the mount frame 140. For instance, the shiftable end connector 216 may be shiftably engaged with the side walls 162 and 164 of the mount frame 140 by locating the projections 218 adjacent the aft frame end 178 and inserting the projections 218 into upright slots 220 defined by the respective side walls 162 and 164 (see FIGS. 6 and 7). Each slot 220 may shiftably receive a respective one of the projections 218 and permit pivotal movement of the upper retainer 142 relative to the mount frame 140. Upper retainer 142 may be shiftable into and out of an uppermost position (see FIGS. 6-8) in which projections 218 engage stops 222 defined by the respective side walls 162 and 164. The stops 222 may terminate corresponding slots 220. Each projection 218 removably engages a respective stop 222 to limit upward movement of the upper retainer 142 beyond the uppermost position.

Upper retainer 142 may also present an upwardly-facing upper guide surface 224 (see FIGS. 6 and 8) that extends axially between the end connectors 212 and 216. The upper retainer 142 may be oriented relative to the mount frame 140 so that the upper guide surface 224 and the lower guide surface 172 face generally in opposite directions (see FIG. 8).

The spring 148 may be supported on the mount frame 140 for engagement with the upper retainer 142. Mount frame 140 may include an upturned post 226 extending upwardly relative to the mount frame base 160 (see FIG. 8). The post 226 may be sized and configured to support the spring 148 for engagement with the upper retainer 142. Spring 148 may extend vertically to operably engage the upper retainer 142 and urge the upper retainer 142 away from the mount frame base 160. Specifically, spring 148 may extend vertically to interengage the mount frame 140 and the upper retainer 142.

Further, spring 148 may be compressed to urge the upper retainer 142 away from the mount frame base 160 and toward the uppermost position. That is, the upper retainer 142 may be biased upwardly by the spring 148 so that the lower guide surface 172 and the upper guide surface 224 are urged into frictional engagement with the hitch receiver 104 when the accessory mount 100 is inserted into the receiver bore 134. As noted above, projections 218 may engage stops 222 of the side walls 162 and 164 to restrict upward shifting of the upper retainer 142.

Upper retainer 142 and spring 148 cooperatively permit shifting of the upper retainer 142 between the uppermost position (see FIG. 8) and a range of retracted positions (for example, see FIG. 3). Although spring 148 may be partially compressed in the uppermost position, it will be appreciated that spring 148 may be further compressed as the upper retainer 142 is shifted downwardly toward the bottom plate 166. For instance, as the upper retainer 142 is shifted forwardly into engagement with the hitch receiver 104, it will be understood that upper retainer 142 may be engaged and urged downwardly by the tube 130.

The projections 218 and slots 220 may be configured to permit shifting of the upper retainer 142 between the uppermost position and retracted positions. As the upper retainer 142 is shifted downwardly from the uppermost position, slots 220 may retain the projections 218 of the retainer body 210 while permitting the projections 218 to slide downwardly away from the stops 222 (see FIG. 3).

Again, the accessory mount 100 may be configured to be slidably inserted into the hitch receiver 104 for removable engagement with the receiver bore 134 of the hitch receiver 104. In the depicted embodiment, the accessory mount 100 may be inserted through the aft end 132 of the hitch receiver 104. Specifically, the forward frame end 176 of the accessory mount 100 may be inserted into the aft end 132 while the aft frame end 178 of the accessory mount 100 is spaced behind the forward frame end 176.

With the forward frame end 176 of the accessory mount 100 inserted into the receiver bore 134, the lower guide surface 172 of the bottom plate 166 may be slidably engaged with the hitch receiver 104. Thus, with the forward frame end 176 of the accessory mount 100 inserted into the receiver bore 134, the accessory mount 100 may be shifted forwardly into the receiver bore 134.

Prior to insertion of the accessory mount 100 into receiver bore 134, upper retainer 142 of accessory mount 100 may be biased into the uppermost position (see FIG. 8). As the accessory mount 100 is advanced forwardly into the receiver bore 134, the upper retainer 142 may be moved into sliding engagement with an upper wall 130a of the tube 130 (see FIG. 3). That is, the upper guide surface 224 of the retainer body 210 moves into sliding engagement with the upper wall 130a of tube 130.

With additional forward shifting of the accessory mount 100 into the hitch receiver 104, upper retainer 142 may be engaged and urged downwardly by the tube 130 (see FIG. 3). Again, the spring 148 is preferably configured to be compressed to permit downward movement of the upper retainer 142 from the uppermost position. As the upper retainer 142 is shifted downwardly, slots 220 permit the projections 218 of the retainer body 210 to slide downwardly while being retained by the slots 220 (see FIG. 3). As the accessory mount 100 is advanced into the receiver bore 134, it will also be understood that tab 174 may slide into engagement with a lower wall 130b of the tube 130 (see FIG. 3).

Accessory mount 100 may be advanced forwardly into the secured position in which the accessory mount 100 is removably secured in place by detents 152 and 154 (see FIG. 4). Prior to insertion of the accessory mount 100 into receiver bore 134, side retainers 144 and 146 of accessory mount 100 may be biased into the outboard position (see FIG. 9). However, as the side retainers 144 and 146 of accessory mount 100 are shifted forwardly into engagement with the hitch receiver 104, side retainers 144 and 146 may be engaged and urged inboard by the tube 130. Again, the spring 150 is preferably configured to be compressed to permit inboard movement of the side retainers 144 and 146 from the outboard position. As the accessory mount 100 is advanced forwardly into the secured position, spring 150 may urge side retainers 144 and 146 to shift outboard so that detents 152 and 154 are biased into engagement with holes 136 (see FIG. 4).

In the secured position, side retainers 144 and 146 may be biased outwardly so that the detents 152 and 154 are urged into frictional engagement with holes 136 (see FIG. 4). In this manner, the detents 152 and 154 may cooperate with the hitch receiver 104 to restrict removal of the accessory mount 100. However, accessory mount 100 may be selectively removed from the secured position by pressing or otherwise advancing the detents out of the holes 136 in receiver 104 and then pulling the accessory mount 100 rearwardly. It is understood that the detents 152 and 154 may be sized and sloped at a sufficiently low incline that pulling of the accessory mount 100 rearward may be sufficient to compress the detents 152 and 154 inward and out of the holes 136 without having to manually press the detents 152 and 154 inward.

One or more components of the hitch receiver 104, the accessory cover 106, and/or the accessory mount 100 may be formed from a sheet metal material. The sheet metal may be formed of one or more metallic materials, such as carbon steel, stainless steel, aluminum, etc. It will also be understood that one or more components of the hitch receiver 104, accessory cover 106, and/or the accessory cover may include a non-metal material, such as a synthetic resin material.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An accessory mount configured to be slidably inserted into a receiver bore of a hitch receiver for removable engagement with the hitch receiver, said accessory mount comprising:
a mount frame having a frame axis along which the accessory mount is inserted and removed relative to the receiver bore of the hitch receiver;
a lower guide associated with the mount frame and presenting a downwardly-facing, first guide surface slidably engaged with the hitch receiver when the accessory mount is inserted in the receiver bore; and
an upper retainer shiftably attached relative to the mount frame and located opposite the lower guide,
said upper retainer presenting an upwardly-facing, second guide surface, with at least part of the upper retainer being biased upwardly so that the first guide surface and the second guide surface are urged into frictional engagement with the hitch receiver when the accessory mount is inserted into the receiver bore.

2. The accessory mount as claimed in claim 1, further comprising:
a spring operably engaging the upper retainer to urge the upper retainer away from the mount frame.

3. The accessory mount as claimed in claim 2,
said mount frame including a post extending upwardly relative to the first guide surface,
said spring being mounted on the post and extending vertically between the mount frame and the upper retainer and biasing the upper retainer away from the mount frame.

4. The accessory mount as claimed in claim 3,
said mount frame including a mount frame base and side walls that extend axially between first and second frame ends, with the side walls projecting from respective side margins of the mount frame base,
said upper retainer being pivotally attached adjacent the first frame end of the mount frame,
said upper retainer including a projection located adjacent the second frame end of the mount frame base,
said mount frame defining a slot that shiftably receives the projection and permits pivotal movement of the upper retainer relative to the mount frame base.

5. The accessory mount as claimed in claim 4,
said mount frame including a stop that terminates the slot, such that engagement of the stop by the projection limits upward movement of the upper retainer relative to the mount frame base.

6. The accessory mount as claimed in claim 1,
said mount frame including a mount frame base and side walls that extend axially between first and second frame ends, with the side walls projecting from respective side margins of the mount frame base,
said mount frame base presenting the downwardly-facing, first guide surface slidably engaged with the hitch receiver when inserted in the receiver bore.

7. The accessory mount as claimed in claim 6,
said upper retainer being pivotally attached adjacent the first frame end of the mount frame,
said upper retainer including a pair of spaced projections located adjacent the second frame end of the mount frame base,
said side walls each defining an upright slot that shiftably receives a respective one of the projections and permits pivotal movement of the upper retainer relative to the mount frame base.

8. The accessory mount as claimed in claim 7,
said side walls each including a stop that terminates a corresponding one of the upright slots, such that engagement of a respective stop by a corresponding one of the pair of spaced projections limits upward movement of the upper retainer relative to the mount frame base.

9. The accessory mount as claimed in claim 1, further comprising:
opposite side retainers operably supported on opposite sides of the mount frame, each of said opposite side retainers presenting an outwardly-facing side guide surface.

10. The accessory mount as claimed in claim 9,
at least one of said opposite side retainers being biased outwardly so that the side guide surfaces are urged into frictional engagement with the hitch receiver when the accessory mount is inserted into the receiver bore.

11. The accessory mount as claimed in claim 10, further comprising:
a spring operably engaging the opposite side retainers and urging the opposite side retainers outwardly away from one another.

12. The accessory mount as claimed in claim 10,
at least one of said opposite side retainers including an elongated body with opposite end connectors, with one of the end connectors being pivotally attached relative to the mount frame and another one of the end connectors being shiftably received relative to the mount frame.

13. The accessory mount as claimed in claim 1, further comprising:
opposite side retainers operably supported by the mount frame and spaced on opposite sides of the upper retainer and lower guide,
said opposite side retainers presenting respective, outwardly-facing detents.

14. The accessory mount as claimed in claim 13,
at least one of said opposite side retainers being biased outwardly so that the detents are urged into frictional engagement with holes presented by the hitch receiver when the accessory mount is inserted into the receiver bore.

15. An accessory mount configured to be slidably inserted into a hitch receiver for removable engagement with a receiver bore of the hitch receiver, said accessory mount comprising:
a mount frame including a mount frame base and side walls that extend axially between first and second frame ends, with the side walls projecting from respective side margins of the mount frame base,
said mount frame base and side walls having a frame axis along which the accessory mount is inserted and removed relative to the receiver bore of the hitch receiver,
said mount frame base presenting a downwardly-facing first guide surface slidably engaged with the hitch receiver when inserted in the receiver bore;
an upper retainer being pivotally attached adjacent the first frame end of the mount frame; and
a spring operably engaging the upper retainer to urge the upper retainer away from the mount frame base,
said upper retainer presenting an upwardly-facing second guide surface, with at least part of the upper retainer being biased upwardly by the spring so that the first guide surface and the second guide surface are urged into frictional engagement with the hitch receiver when the accessory mount is inserted into the receiver bore,
said upper retainer including a pair of spaced projections located adjacent the second frame end of the mount frame base,
said side walls each defining a slot that shiftably receives a respective one of the projections and permits pivotal movement of the upper retainer relative to the mount frame base,
said side walls each including a stop that terminates a corresponding slot, with engagement of a respective stop by a corresponding projection limiting upward movement of the upper retainer relative to the mount frame base.

16. The accessory mount as claimed in claim 15, further comprising:
opposite side retainers operably supported by the mount frame and spaced on opposite sides of the upper retainer and mount frame base,
said opposite side retainers presenting respective, outwardly-facing side guide surfaces.

17. The accessory mount as claimed in claim 16,
at least one of said opposite side retainers being biased outwardly so that the side guide surfaces are urged into frictional engagement with the hitch receiver when the accessory mount is inserted into the receiver bore.

18. The accessory mount as claimed in claim 17, further comprising:
a second spring operably engaging the opposite side retainers and urging the opposite side retainers outwardly away from one another.

19. The accessory mount as claimed in claim 17,
at least one of said opposite side retainers including an elongated body with opposite end connectors, with one of the end connectors being pivotally attached relative to the mount frame and another one of the end connectors being shiftably received relative to the mount frame.

20. The accessory mount as claimed in claim 15, further comprising:
opposite side retainers operably supported by the mount frame and spaced on opposite sides of the upper retainer and lower guide,
said opposite side retainers presenting respective, outwardly-facing detents.

21. The accessory mount as claimed in claim 20,
at least one of said opposite side retainers being biased outwardly so that the detents are urged into frictional engagement with holes presented by the hitch receiver when the accessory mount is inserted into the receiver bore.
